(19) United States
(12) Patent Application Publication
(10) Pub. No.: US 2015/0313408 A1
(43) Pub. Date: Nov. 5, 2015

(54) MOJOE GRIDDLE

(71) Applicant: Camron Stone, Arcadia, CA (US)

(72) Inventor: Camron Stone, Arcadia, CA (US)

(21) Appl. No.: 14/266,787

(22) Filed: Apr. 30, 2014

(51) Int. Cl. A47J 37/06

(52) U.S. Cl. CPC A47J 37/067

(57) ABSTRACT

A cooking griddle to be placed on any heat source to provide a simple, evenly heated surface that is portable and easy to clean, a large flat heating surface and a plurality of standoff legs attached vertically to the heating surface. The standoff legs are equidistant from each other to provide stability and support for the griddle.

### CROSS-REFERENCE TO RELATED APPLICATIONS

This Application claims the benefit under 35 U.S.C. §119(e) of U.S. Provisional patent application Ser. No. 15/690,945, filed on May 3, 2013, the contents of which are incorporated herein by reference in their entirety.

### FIELD OF THE INVENTION

This invention relates generally to the field of outdoor cooking grills and griddles of the type utilizing gas, charcoal or wood to cook meat or other foods for consumption, and more particularly to a griddle designed to be placed on any outdoor cooking grill to provide a simple, evenly heated surface that is portable and easy to clean.

### BACKGROUND

Typical outdoor grills for cooking meat and other food products comprise a heat source and a cooking grid for supporting the food, both contained within a housing comprising a base and a removable or hinged cover that together define a cooking chamber. The heat source is typically charcoal, wood, smoke or gas. In one style of cooking, the meat is cooked for an extended length of time at a relatively low temperature. Advantageously, each of these grills provides a means for enjoying food that can be purchased inexpensively and flavorful. However, the spaces provided in the grills of each of these cooking devices does limit the amount and size of items that can be cooked simultaneously. For instance, cooking pancakes on an outdoor grill requires an additional griddle that is sized correctly to fit the grill. However, even a standard griddle that could be used on a grill poses significant problems. For example, uneven heating, or hotspots, prevalent in outdoor grills means that the temperature is not evenly distributed and some foods may not be cooked sufficiently or overcooked. Additionally, cleanup can be troublesome on currently available griddles due to the fact that they were intended for indoor use, not outdoor use.

It is an object of this invention to provide an improved a griddle designed to be placed on any outdoor cooking grill to provide a simple, evenly heated surface that is portable and easy to clean, wherein the structure of the device insures that it can be easily and readily used with standard grills.

Therefore there is a need for a griddle designed to be placed on any outdoor cooking grill, or other heat source, to provide a simple, evenly heated surface that is portable and easy to clean.

### SUMMARY

A cooking griddle to be placed on any heat source to provide a simple, evenly heated surface that is portable and easy to clean comprising a large flat heating surface and a plurality of standoff legs attached vertically to the heating surface. Each standoff leg is equidistant from the other legs to provide stability and support for the griddle, preferably each standoff leg is 120 degrees from the other legs. The standoff legs are at least one inch high to provide airflow between a heat source and the heating surface. The heating surface further comprises a circular shape comprising a center portion and a lip portion distal from the center portion and an indent at to lock the heating surface securely to a grill. The standoff legs are not connected at the center of the heating surface, leaving an approximate six inch circular clear area so that heat can flow evenly out to the entire heating surface providing more even heating.

The griddle further comprises a plurality of pivotal leg stand supports attached to the heating surface. The plurality of pivotal leg stand supports are also equidistant from one another, preferably 120 degrees, and equidistant from the plurality of pivotal leg stand supports. In one embodiment, the pivotal legs are adjustable.

The griddle further comprises at least one removable handle connectable to the heating surface. The at least one removable handle comprises a base portion and at least one tong made of a material strong enough to carry the weight of the griddle without bending or breaking, preferably made of steel. The at least one removable handle comprises two tongs for stability during transport and safety when moving the griddle during cooking.

The heating surface of the griddle can be made of any suitable metal that can withstand repeated exposure to temperatures up to 800 degrees Fahrenheit and retain heat for a longer period of time to evenly distribute the heat, eliminating hot spots. Preferably, the griddle is made of plate steel or cast iron at least 0.25 inches thick.

The plurality of standoff legs and the pivotal supports can be a single structure, where a pivot point of the combined structure can be attached to the heating surface of the griddle so that the standoff leg can swing down from the griddle's heating surface to provide a non-adjustable height to the griddle for various heat sources. The standoff legs can further comprise storage holes for storage of the at least one removable handle with the griddle when the griddle is not in use.

### BRIEF DESCRIPTION OF THE DRAWINGS

These and other features, aspects and advantages of the present invention will become better understood with regard to the following description, appended claims, and accompanying figures where:

FIG. 1 is a perspective view of a griddle designed to be placed on any outdoor cooking grill to provide a simple, evenly heated surface that is portable and easy to clean, according to one embodiment;

FIG. 2 is a top view of the cooking griddle of FIG. 1;

FIG. 3 is a right side view of the cooking griddle of FIG. 1;

FIG. 4 is a bottom view of the cooking griddle of FIG. 1;

FIG. 5 is a close-up side view of a standoff leg according to one embodiment;

FIG. 6 is a close-up side view of a standoff leg according to another embodiment;

FIG. 7a is a top view diagram of a handle for carrying the cooking griddle of FIG. 1; and

FIG. 7b is a side view diagram of a handle for carrying the cooking griddle of FIG. 1.

### DETAILED DESCRIPTION

The cooking griddle described herein overcomes the limitations of the prior art by providing a griddle designed to be placed on any heat source to provide a simple, evenly heated surface that is portable and easy to clean. The cooking griddle can also be placed on an open campfire or other heat sources in addition to the grills of the prior art.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any system, any device or part of a system or device disclosed in this disclosure will be determined by its intended use.

Methods and devices that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising,” “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific detail. Well-known structures and techniques may not be shown in detail in order not to obscure the embodiments.

In the following description, certain terminology is used to describe certain features of one or more embodiments of the invention.

The term “heat source” refers to anything that produces heat sufficient to cook food, such as, for example, a grill, a stove, kettle style bar-b-ques and a campfire among others.

Various embodiments provide a device and a method for a griddle designed to be placed on any heat source to provide a simple, evenly heated surface that is portable and easy to clean. The griddle will now be disclosed in detail.

Referring now to FIG. 1, there is shown a perspective view 100 of a griddle 102 designed to be placed on any outdoor heat source, such as a cooking grill, to provide a simple, evenly heated surface 120 that is portable and easy to clean. The griddle 102 comprises a large flat heating surface 120 with three standoff legs 104, 106 and 108 attached vertically to the heating surface 120. Each of the standoff legs 104, 106 and 108 is equidistant from the other legs to provide stability and support for the griddle 102. Additionally, the positioning of the standoff legs 104, 106 and 108 at three equidistant points on the heated surface 120 of the cooking griddle 100 provide stability on any grill or stove used as the heat source. The three standoff legs 104, 106 and 108 allow air to travel between the heat source in a grill and the heating surface of the griddle 102. This provides adequate air to prevent uneven heat from the grill due to the lack of oxygen. Also, each of the three standoff legs 104, 106 and 108 are notched to lock the heating surface securely to the grill of commonly found kettle type outdoor cooking grills providing additional security. The three standoff legs 104, 106 and 108 are not connected at the center of the griddle's 102 heating surface 120, leaving an approximate six inch circular clear area. This feature allows heat from a centralized heat source such as, for example, a camp stove burner to flow evenly out to the entire edge of the griddle 102 providing more even heating of the griddle 102.

Additionally, a plurality of pivotal leg stand supports 110, 112 and 114 are also attached to the heating surface 120. A plurality of pivotal legs can be connected to the pivotal leg stand supports 110, 112 and 114 to support the griddle 102 over a variety of heat sources, such as, for example, a campfire without the need to place a grill or a grid across the campfire. The plurality of pivotal leg stand supports 110, 112 and 114 can be welded near the edge of the heating surface 102 of the griddle 102 and equidistantly spaced from one another to provide support for the griddle 102. In a preferred embodiment, there are three pivotal leg stand supports 110, 112 and 114. The pivotal leg stand supports 110, 112 and 114 provide the capability for the user to easily attach the pivotal legs (not shown) to the griddle 102. With the pivotal legs attached, the griddle 102 can be easily set over the campfire leaving enough area under the griddle 102 for the fire to burn and for additional wood to be added without removing the griddle 102. Additionally, the pivotal legs can be adjustable to raise and lower the griddle 102 closer or farther away from the heat source to adjust cooking time and temperature. Also, the pivotal legs provide ample air flow so that the heat source is not oxygen starved potentially extinguishing the heat source. As will be understood, other configurations and additional support structures can be added to the griddle 102 without improving upon the basic functionality presented herein.

The griddle 102 also comprises at least one removable handle 116 and 118 connectable to the griddle 102. In this example, the removable handles 116 and 118 comprise a base portion and two tongs. As will be understood by those with skill in the art with reference to this disclosure, there are other possible means of attaching a removable handle to move the griddle 102 from place to place without burning the user. Additionally, the handles can be used to store the griddle 102 by hanging the griddle 102 by the handle in a storage area. By providing removable handles, the handles do not get hot, as is the case with conventional griddles. Therefore, when cooking is complete, the handles 116 and 118 can be re-attached and the griddle 102 can be removed from the heat source without the use of oven mitts or other means for protecting a users hands from the heated surface 120. Additionally, while cooking or cleaning, there are no handles 116 and 118 that can get in the way of the food, spatula or cleaning utensils as is a common problem in the prior art. The griddle 102 can be carried and moved using a removable handle. Although a single tong handle can be used, the preferred embodiment comprises at least one double tong handle 116 for stability during transport and safety when moving the griddle 102 during cooking. In yet another preferred embodiment, there are provided two, double tong handles 116 and 118 that provide a high level of stability while carrying the griddle 102. Also, the double tong design of the handles 116 and 118 allows the griddle 102 to be carried vertically using a single handle 116 or horizontally using two the handles 116 and 118.

Unlike grills, pans and other prior art griddles, the present invention can be used on multiple heat sources without the limitations inherent in the prior art. For example, a griddle that can be used on an indoor stove top would not be safe to use over a campfire or a grill as the handles would become too hot for the user to touch safely without oven mitts or some other form of protection. Also, the griddle has no support so that is can easily slide off the heat source. Additionally, the material that the griddle is constructed of may not be able to handle the amount of heat generated by the heat source without damaging the prior art griddle.

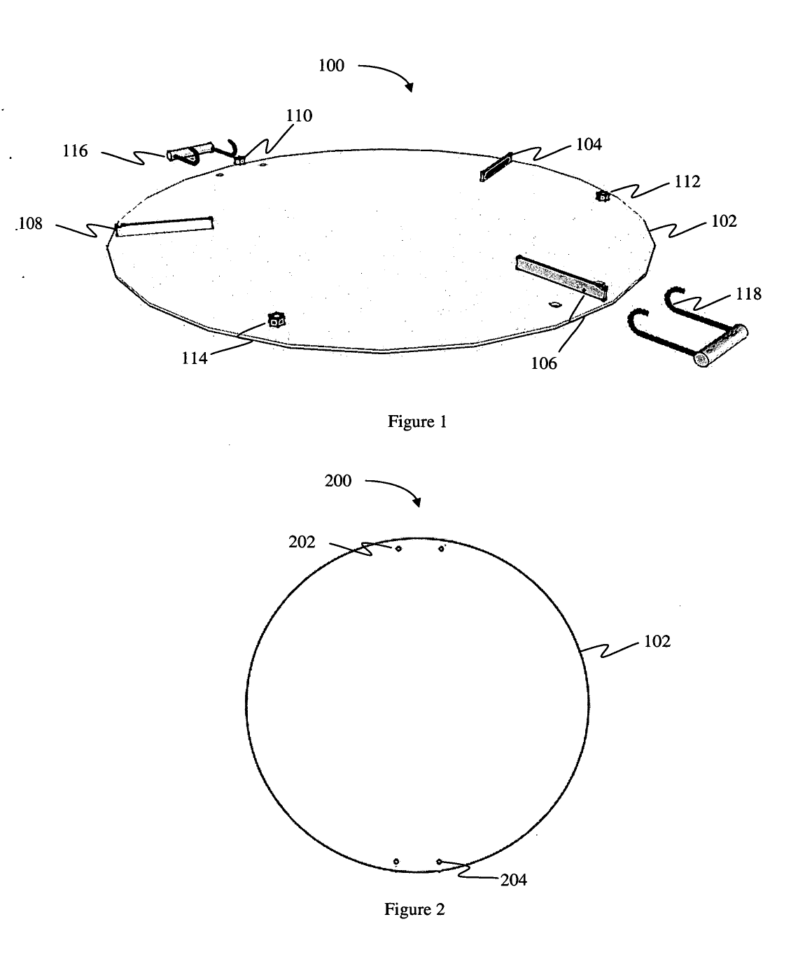

Referring now to FIG. 2, there is shown a top view of the cooking griddle 102. As can be seen, the griddle cooking surface 206 is circular with no lip at the edge. This allows grease and other unwanted food bits to freely drip off the edge of the griddle 102 onto the ground of a campfire while cooking. The griddle 102 also allows for easy cleaning of the griddle 102 with a sharp edged spatula, simply scrape the remaining food or grease off the edge of the griddle 102. Also, food can be slide directly off the griddle 102 onto a serving tray or a plate by placing the plate or tray under the cooking surface 206. The griddle 102 can be made of any suitable metal that can withstand repeated exposure to temperatures up to 800 degrees Fahrenheit, or approximately 425 degrees Celsius. In a preferred embodiment, the griddle 102 is made of plate steel. In another preferred embodiment, the griddle 102 is made of cast iron. Both of the preferred embodiments provide useful properties over other materials, such as aluminum. At a depth of ¼ of an inch, plate steel or cast iron will retain heat for a longer period of time and the heat will be evenly distributed, eliminating hot spots. Although materials such as aluminum can be used where weight is a concern, there is a potential for uneven heat distribution. Further, both plate steel and cast iron provide durable surfaces for both cooking and cleaning without loosing part of the surface during a particularly heavy cleaning as can happen with Aluminum. Also, both steel plate and cast iron are known for their ability to be “seasoned,” that is a small amount of the food, oils and spices used on a regular basis on the cooking surface 206 will remain on the cooking surface 206 and add additional flavor to other items cooked on the griddle 102. Seasoning also increases the “non-stick” characteristics of the cooking surface 206 in a similar fashion that is found using iron skillets in the prior art.

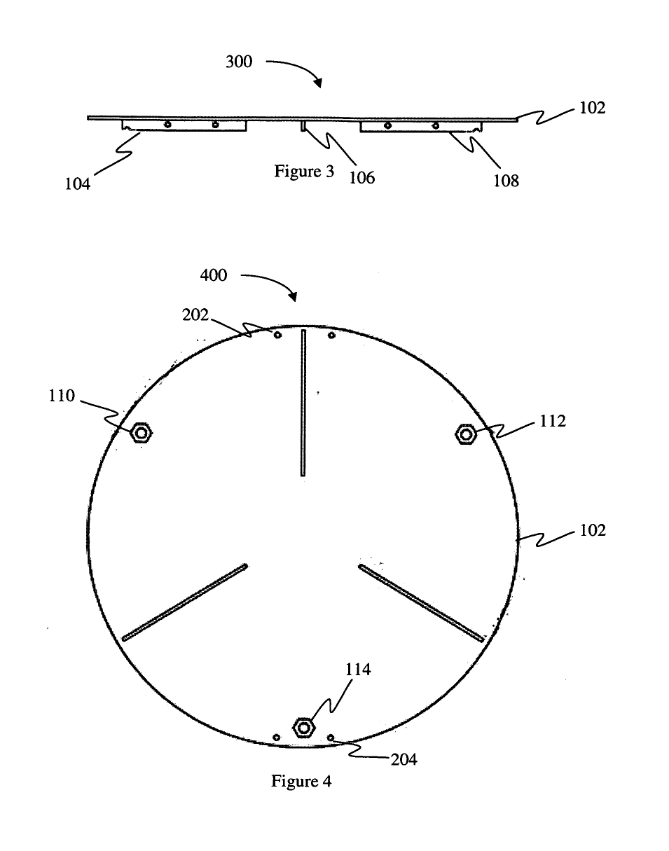

Referring now to FIG. 3, there is shown a right side view 300 of the griddle 102. As can be seen, the griddle 102 provides a shallow profile for easy storage as discussed above. Other embodiments contemplated are removable standoff legs 104, 106 and 108 or foldable standoff legs 104, 106 and 108 to make storage easier while maintaining the necessary air gap when the griddle 102 is in use on certain heat sources, such as a grill.

Referring now to FIG. 4, there is shown a bottom view 400 of the griddle 102 of FIG. 1. As can be seen in this embodiment, the standoff legs 104, 106 and 108 and the pivotal leg stand supports 110, 112 and 114 are equidistant from each other in an alternating pattern. The standoff legs 104, 106 and 108 also provide at least three points of contact when the griddle 102 is used without the pivotal supports 110, 112 and 114. This provides stability for the grill when used on top of other grills, such as, for example, a round Webber® grill and others that are commonly found in the prior art. The pattern is for convenience of manufacture only and not intended to be limiting. However, in a preferred embodiment, the pattern of the standoff legs 104, 106 and 108 and the pivotal supports 110, 112 and 114 are at a 120 degree angles from each other on the heating surface 120 of the griddle 102. This configuration provides the greatest stability for the griddle 102. In one embodiment, the pivotal supports 110, 112 and 114 can be adjustable to raise and lower the heated surface 120 of the griddle 102 from the heat source.

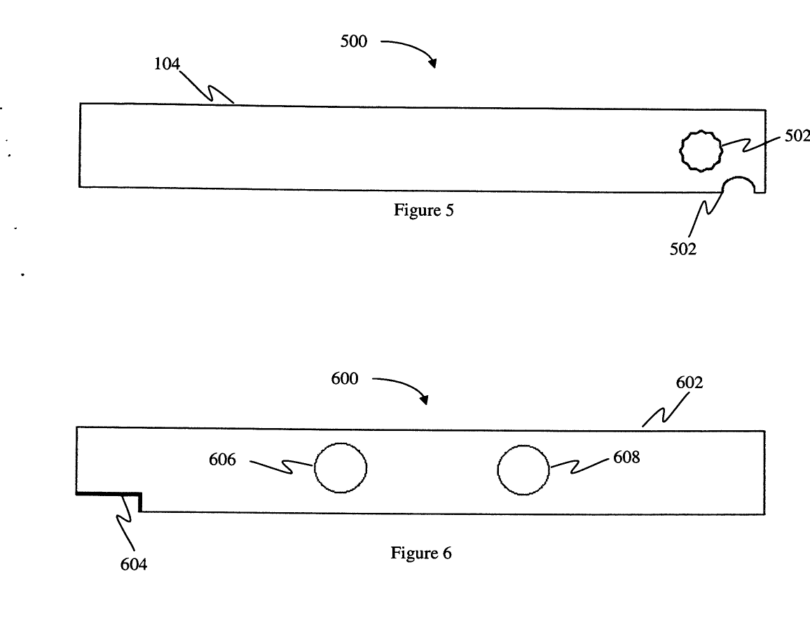

Referring now to FIG. 5, there is shown a close-up side view 500 of a standoff leg 104 according to one embodiment. As can be appreciated, the standoff legs 104 and the pivotal supports 110, 112 and 114 are combined into a single structure, as shown. The pivot point 502 of the combined structure can be attached to the heating surface 120 of the griddle 102 so that the standoff leg 104 can swing down from the griddle's 102 heating surface 120 to provide a non-adjustable height to the griddle 102 for various heat sources, such as a campfire. Additionally, there standoff leg 104 comprises an indent so that the griddle 102 can also be used on a grill found in the prior art. In this embodiment, the indent is semi-circular, but this is not meant to be limiting and other indents to provide support for existing heat sources is contemplated.

Referring now to FIG. 6, there is shown a close-up side view of a standoff leg 602 according to another embodiment. As can be seen, the standoff leg 602 in this embodiment is not pivotal, but is attached to the heating surface 120 of the griddle 102. The indent 604 is also larger and longer to fit a larger variety of prior art heating sources to prevent the griddle 102 from sliding off the heat source. Additionally, the standoff leg 602 comprises two tong storage holes to hang the tongs 116 and 118 from when the griddle 102 is stored in a vertical position.

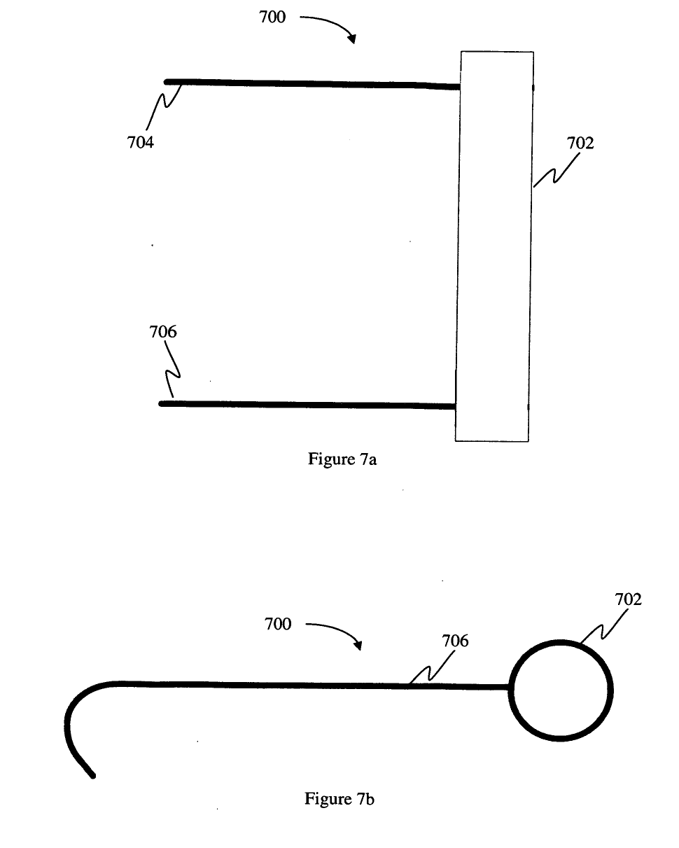

Referring now to FIGS. 7a and 7b, there is shown a top view and a side view diagram of a handle 700 for carrying the griddle 102 of FIG. 1. As can be seen, the handle 700 comprises a base portion 702 and two curved tongs 704 and 706. The base portion 702 can be made of any material, such as for example, wood, silicone, aluminum and steel. Preferably, the base portion 702 is made of steel. The tongs 704 and 706 are made of a material that is strong enough to carry the weight of the griddle 102 without bending or breaking. Preferably, the tongs 704 and 706 are comprised of steel. In this embodiment, the tongs 704 and 706 are curved into a semi-circular shape to be placed in the carrying holes 202 and 204. As will be understood by those with skill in the art with reference to this disclosure, the tongs can also be shaped at an angle (not shown). An angular shape would allow the handle to lay flat against the griddle 102 when placed in griddle holes 202 and 204 for storage when the griddle 102 is not in use.

What has been described is a new and improved griddle designed to fit over available heat sources, such as grills and campfires to provide a simple, evenly heated cooking surface that is portable and easy to clean, overcoming the limitations and disadvantages inherent in the related art.

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. §112.

1. A cooking griddle to be placed on any heat source to provide a simple, evenly heated surface that is portable and easy to clean, the cooking griddle comprising:
a) a large flat heating surface; and
b a plurality of standoff legs attached vertically to the heating surface.

2. The griddle of claim 1, wherein each standoff leg is equidistant from the other legs to provide stability and support for the griddle.

3. The griddle of claim 2, wherein each standoff leg is 120 degrees from the other legs to provide stability and support for the griddle.

4. The griddle of claim 1, wherein the standoff legs are at least one inch high to provide airflow between a heat source and the heating surface.

5. The griddle of claim 1, wherein the heating surface further comprises a circular shape.

6. The griddle of claim 1, wherein the heating surface comprises a center portion and a lip portion distal from the center portion.

7. The griddle of claim 6, wherein the standoff legs comprise an indent at to lock the heating surface securely to a grill.

8. The griddle of claim 1, wherein the standoff legs are not connected at the center of the heating surface, leaving an approximate six inch circular clear area so that heat can flow evenly out to the entire heating surface providing more even heating.

9. The griddle of claim 1 further comprising a plurality of pivotal leg stand supports attached to the heating surface.

10. The griddle of claim 9, wherein the plurality of pivotal leg stand supports are equidistant from one another.

11. The griddle of claim 1, wherein the plurality of pivotal leg stand supports are 120 degrees from one another.

12. The griddle of claim 1, wherein the plurality of pivotal leg stand supports are equidistant the standoff legs.

13. The griddle of claim 12 further comprising a plurality of pivotal legs connected to the pivotal leg stand supports.

14. The griddle of claim 13, wherein the pivotal legs are adjustable.

15. The griddle of claim 1 further comprising at least one removable handle connectable to the heating surface.

16. The griddle of claim 15, wherein the at least one removable handle comprises a base portion and at least one tong.

17. The griddle of claim 16, wherein the at least one removable handle is made of a material strong enough to carry the weight of the griddle without bending or breaking.

18. The griddle of claim 16, wherein the at least one removable handle is made of steel.

19. The griddle of claim 16, wherein the at least one removable handle comprises two tongs for stability during transport and safety when moving the griddle during cooking.

18. The griddle of claim 1, wherein the heating surface can be made of any suitable metal that can withstand repeated exposure to temperatures up to 800 degrees Fahrenheit and retain heat for a longer period of time to evenly distribute the heat, eliminating hot spots.

19. The griddle of claim 18, wherein the heating surface is made of plate steel.

20. The griddle of claim 19, wherein the plate steel is at least 0.25 inches thick.

21. The griddle of claim 18, wherein the heating surface is made of cast iron.

22. The griddle of claim 21, wherein the cast iron is at least 0.25 inches thick.

23. The griddle of claim 1, wherein the plurality of standoff legs and the pivotal supports are a single structure.

24. The griddle of claim 23, wherein a pivot point of the combined structure can be attached to the heating surface of the griddle so that the standoff leg can swing down from the griddle's heating surface to provide a non-adjustable height to the griddle for various heat sources.

25. The griddle of claim 1, where the standoff legs can further comprise storage holes for storage of the at least one removable handle with the griddle when the griddle is not in use.
